(19) United States
(12) Patent Application Publication
(10) Pub. No.: US 2018/0114399 A1
(43) Pub. Date: Apr. 26, 2018

(54) GAME MACHINE

(71) Applicants: Brian Riggles, St. Louis, MO (US); Marty Luepker, St. Louis, MO (US); Ronald Blue, St. Louis, MO (US)

(72) Inventors: Brian Riggles, St. Louis, MO (US); Marty Luepker, St. Louis, MO (US); Ronald Blue, St. Louis, MO (US)

(21) Appl. No.: 15/790,821

(22) Filed: Oct. 23, 2017

Related U.S. Application Data
(60) Provisional application No. 62/411,346, filed on Oct. 21, 2016.

(51) Int. Cl. G07F 17/32

(52) U.S. Cl. CPC G07F 17/3211; G07F 17/3246; G07F 17/3216

(57) ABSTRACT

A game machine, comprising a housing with a plurality of upright walls, said housing being adapted to accommodate playing means, in particular pick-up means for picking up one or more objects; said upright walls of the housing comprising at least one translucent or semi-transparent panel; a pattern or array of single-color LEDs being provided on the inner side of the housing behind said at least one translucent or semi-transparent panel, said single-color LEDs being connected to a controller for controlling the combination and blending of red, blue and green colored single-color LEDs, said controller and said at least one translucent or semi-transparent panel being adapted to impart a determined impression of color to the at least one panel.

### CROSS-REFERENCE TO RELATED APPLICATIONS

This application claims the benefit of U.S. Provisional Application No. 62/411,346, entitled GAME MACHINE, filed on Oct. 21, 2016. The disclosure of the above application is incorporated herein by reference.

### STATEMENT REGARDING FEDERALLY SPONSORED RESEARCH

Not applicable.

### BACKGROUND

The present invention relates to a game machine comprising a housing adapted to accommodate playing means, in particular pick-up means for picking up one or more objects. The present invention also relates to an assembly of such game machines.

According to an embodiment of the invention, the game machine comprises a housing with a number of upright walls, wherein the housing is adapted to accommodate playing means, in particular pick-up means such as a grabber or claw for picking up one or more prizes. The upright walls of the housing comprise at least one translucent or semi-transparent panel. A pattern or array of closely spaced single-color LEDs is provided inside the housing behind this at least one translucent or semi-transparent panel. The single-color LEDs are connected to a control unit for controlling the color emitted by each single-color LED. The control unit and the at least one translucent or semi-transparent panel are adapted to impart a determined impression of color to the at least one panel.

According to a preferred embodiment of the invention, the pattern or array of single-color LEDs is arranged such that a substantially uniform impression of color is imparted to said at least one translucent or semi-transparent panel. Preferably, the single-color LEDs are red, green, and blue LEDs capable of covering the full color spectrum. In that way, an upright wall of the housing can be given a particular color impression depending on the wishes of the user. Other single-color LED's can also be used to create differing effects.

According to another embodiment of the invention, the at least one translucent or semi-transparent panel is manufactured from a material with a light transmission lying between 10% and 60%, preferably between 20% and 50%, and more preferably between 35% and 45%. The at least one translucent or semi-transparent panel is preferably manufactured from a white translucent material having good light diffusion properties. Typically the material of the translucent or semi-transparent panel has a light diffusion factor lying between 0.70 and 1.00.

According to a further aspect of the invention, the at least one translucent or semi-transparent panel may comprise a relief, wherein a pattern or array of single-color LEDs is arranged in this relief. According to a possible embodiment, the pattern or array of single-color LEDs is arranged along the edge of this relief, such that the central emission direction of the LEDs is directed substantially toward the inner side of the relief.

According to another embodiment, the pattern or array of single-color LEDs is arranged such that the central emission direction of each LED thereof is substantially parallel to the translucent or semi-transparent panel behind which said LED is provided. In that way light spots on the panel are avoided and a substantially uniform impression of color is imparted to the panel.

According to another embodiment, the upright walls of the housing comprise a front wall and a first side wall adjacent the front wall. The front wall comprises at least one lower front panel and a semi-transparent panel mounted above the translucent or semi-transparent panel. In a similar way, the first side wall may comprise a translucent lower side panel and a semi-transparent panel mounted above the translucent lower side panel.

According to another embodiment of the invention, the game machine comprises: a pick-up device, such as for example a grabber or a claw or a vacuum head, for picking up one or more objects, in particular one or more prizes to be won, in the housing; one or more positioners controllable by a user for placing the pick-up device over one or more objects; a central game controller for controlling drive means of the pick-up means; a housing having a number of upright walls comprising at least one translucent or semi-transparent panel; a pattern or array of single-color LEDs being provided inside the housing behind said at least one translucent or semi-transparent panel, said single-color LEDs being connected to a control unit for controlling the color emitted by each single-color LED; wherein said central game controller is preferably coupled to the control unit.

According to another embodiment of the invention, the game machine comprises a housing with a number of upright walls and a translucent horizontal platform inside the housing, on which platform for instance prizes can be arranged. The housing typically comprises playing components such as pick-up devices for picking up one or more prizes arranged on the translucent horizontal platform. A pattern or array of single-color LEDs is provided inside the housing and is connected to a control unit for controlling the color emitted by each single-color LED. Preferably the pattern or array of single-color LEDs is provided under the translucent platform, wherein the control unit and the translucent platform are adapted to impart a determined impression of color to the platform.

According to another embodiment of the present invention, the game machine comprises a housing with a number of upright walls and a horizontal platform inside the housing. On the horizontal platform granules are arranged. The prizes can be arranged above the granules. A pattern or array of single-color LEDs is provided inside the housing underneath this platform. The single-color LEDs are connected to a control unit for controlling the color emitted by each single-color LED. The control unit, the horizontal platform and the granules are adapted to impart a determined impression of color to the granules. According to a variant thereof, the pattern or array of single-color LEDs can also be arranged above the horizontal platform. In that case, the single-color LEDs are preferably positioned to emit light in the direction of the granules, such that colored glow is created through the granules.

According to another embodiment of the present invention, there is provided an assembly of at least two game machines as disclosed above. The control unit of each game machine of the assembly is preferably adapted to be able to impart a determined impression of color at the same moment in time, to the panels of each game machine of the assembly. The impression of color can differ for one or more game machines of the at least two game machines.

According to another aspect of the assembly of the invention, a synchronization unit is provided for the assembly. The synchronization unit is coupled to each control unit for the purpose of synchronizing each control unit with that of an adjacent game machine.

### DESCRIPTION OF THE DRAWINGS

In the accompanying drawings which form part of the specification:

FIG. 1 is a perspective view of a game machine incorporating a first embodiment of the present invention;

FIG. 2A, is a front view of the front translucent or semi-transparent panel of the game machine of FIG. 1 in a disassembled position;

FIG. 2B is a schematic front view a first embodiment of a support plate with LEDs against which the front translucent or semi-transparent panel of FIG. 2A is mounted;

FIG. 2C is a schematic front view a second embodiment of the support plate of FIG. 2A with LEDs against which the front translucent or semi-transparent panel is mounted;

FIG. 2D is a schematic cross-sectional view of a portion of the support plate of FIG. 2B through line D-D;

FIG. 3A is a front view of a translucent or semi-transparent panel positioned at the bottom of one of the side walls of the game machine of FIG. 1;

FIG. 3B is a schematic front view of a first embodiment of a support plate with LEDs against which the panel of FIG. 3A is mounted;

FIG. 3C is a schematic front view of a second embodiment of a support plate with LEDs against which the panel of FIG. 3A is mounted;

FIG. 4 is a schematic detail view in disassembled position of the edge between the front wall 101 and the side wall 102 of the game machine of FIG. 1;

FIG. 5A shows a schematic view of the translucent top panel of the game machine of FIG. 1;

FIG. 5B shows a schematic view of a portion of the support plate with LEDs against which this top panel of FIG. 5A is mounted;

FIG. 6 is a schematic drawing of two adjacent game machines according to one embodiment of the present invention;

FIGS. 7A-C each show a number of interconnected game machines to illustrate various schematic applications of one or more of the embodiments of the present invention;

FIG. 8 is a schematic perspective view of an embodiment of a game machine largely similar to that of FIG. 1, in partial disassembly;

FIG. 9 is a side view of an embodiment of a grab crane with positioning system oriented within the cabinet of a game machine according to one or more embodiments of the present invention;

FIG. 10 is a view similar to the view of FIG. 9, but wherein a portion of the grab crane has been removed from the cabinet of the game machine;

FIG. 11 is a schematic front view of another embodiment of a grab crane with a positioning system according to one or more embodiments of the present invention.

FIG. 12 is a photograph of one embodiment of a pattern or array of single-color LEDs affixed to a flexible strip, the strip being attached to an upright wall of a game machine such as the game machine of FIG. 1, according to one or more embodiments of the present invention;

FIG. 13 is a photograph of the front of one embodiment of a front translucent or semi-transparent panel for the game machine of the present invention;

FIG. 14 is a photograph of the backside of one embodiment of a front translucent or semi-transparent panel for the game machine of the present invention;

FIG. 15 is a photograph of the front of a game machine incorporating features of the present invention including the front translucent or semi-transparent panel of FIG. 13, and depicting various of the single-color LEDs positioned behind the panel in an illuminated state;

Corresponding reference numerals indicate corresponding parts throughout the several figures of the drawings.

### DETAILED DESCRIPTION

The following detailed description illustrates the claimed invention by way of example and not by way of limitation. The description clearly enables one skilled in the art to make and use the disclosure, describes several embodiments, adaptations, variations, alternatives, and uses of the disclosure, including what is presently believed to be the best mode of carrying out the claimed invention. Additionally, it is to be understood that the disclosure is not limited in its application to the details of construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting.

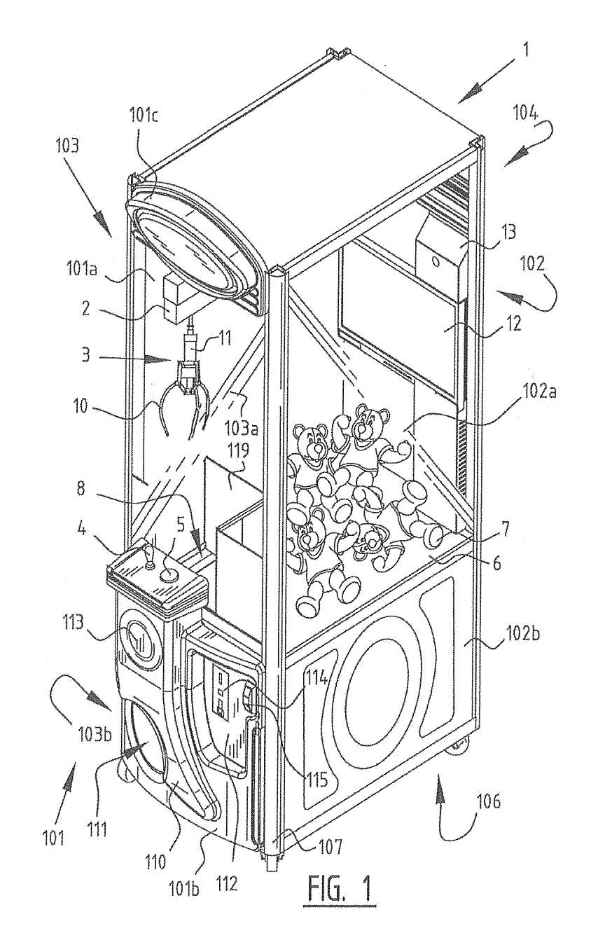

FIG. 1 shows a game machine having a cabinet 1 in which a number of prizes 7, which may or may not differ from each other, are present. These prizes 7 typically lie on a horizontal platform 6 at a certain height above the ground. A horizontally displaceable carriage 2 is provided in the upper part of cabinet 1, from which carriage a pick-up means, here a grabber 3, is suspended. Grabber 3 typically comprises three grabbing claws 10 and drive means 11 for opening and closing said grabbing claws, which drive means 11 can be controlled from a central control unit (not shown).

Cabinet 1 is further provided with game controls, which are intended to be operated by a player. In the shown example the carriage can be displaced in a horizontal field using a joystick 4, and the grabber dropped by depressing a button 5. The skilled person will appreciate that other means such as for example arrow keys are also suitable instead of a joystick. One or more additional buttons may be further provided, for example a start button, a button by which a player can indicate that he or she wishes to make a grab attempt, and/or a button with which a second or further grab attempt can be made at the position where the grabber has come up empty or at the position where the object was lost. Once a user has grabbed a prize 7 with grabber 3, this prize is carried to prize compartment 8. Note that the size of prize compartment 8 can be adjustable by making wall 119 adjustable.

Although a specific embodiment of a game machine with a grabber 3 is described here, the skilled person will appreciate that the novel features of the present invention are also applicable to any other game machine in which other game means are provided in a cabinet or housing, wherein it is for instance possible to envisage coin and token games and games of skill.

Cabinet 1 consists essentially of a front wall 101, two side walls 102, 103, a rear wall 104, an upper wall 105 and a bottom 106. Front wall 101 here consists essentially of an upper translucent or semi-transparent panel 101a, a lower translucent or semi-transparent panel 101b and an (optionally) translucent or semi-transparent top panel 101c. Each side wall likewise comprises an upper translucent or semi-transparent panel 102a, 103a. If the game machine has one or two free side walls, i.e., a side wall against which another device is placed, it may then be advantageous to also provide these one or two side walls at the bottom with a translucent or semi-transparent panel 102b, 103b, whereby a determined color can also be given to lower side panel 102b, 103b, see further. Along the edge between the front wall and a side wall an elongate translucent profile can further be provided extending between the lower part and upper part of the cabinet. In the example shown in FIG. 1 such a profile 107 is provided along the whole upright edge between front wall 101 and side wall 102.

The one or more lower translucent or semi-transparent panels 101b, and optionally 101c and/or 102b and/or 103b and/or profile 107 and/or the bottom 106 and/or the platform 6 must provide a desired degree of light diffusivity and are preferably manufactured from a high-quality vandal-roof plastic, typically a material with a light transmission lying between 10% and 60%, preferably between 30% and 50%, and still more preferably between 35% and 45%. The translucent or semi-transparent panel is typically manufactured from a translucent material, such as a translucent polycarbonate having good light diffusion properties. The material typically has a white color, and preferably has a light diffusion factor lying between 0.70 and 1.00 (DIN 5036 test method), and lying for instance between 0.75 and 0.90. Examples of suitable commercially available materials are Makrolon® GP or Lexan SG305-OB. Of course, other light diffusing translucent or semi-transparent materials of colors other than white can be used in order to achieve varying desired effects.

The one or more light diffusing translucent or semi-transparent panels can for instance be formed by a vacuum forming technique. The average thickness of the panel typically lies between 2 and 10 mm, and preferably between 3 and 7 mm. Note that the thickness can vary between the different zones of the panel as a consequence of the forming operation.

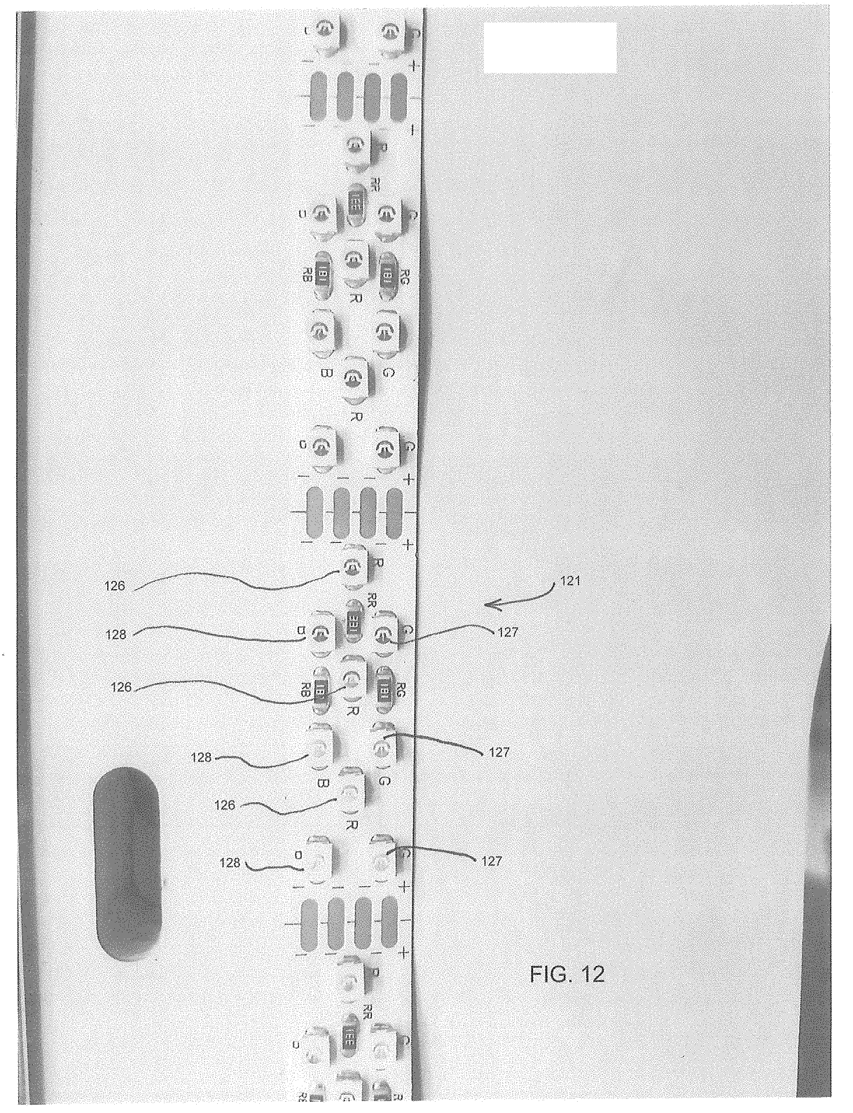

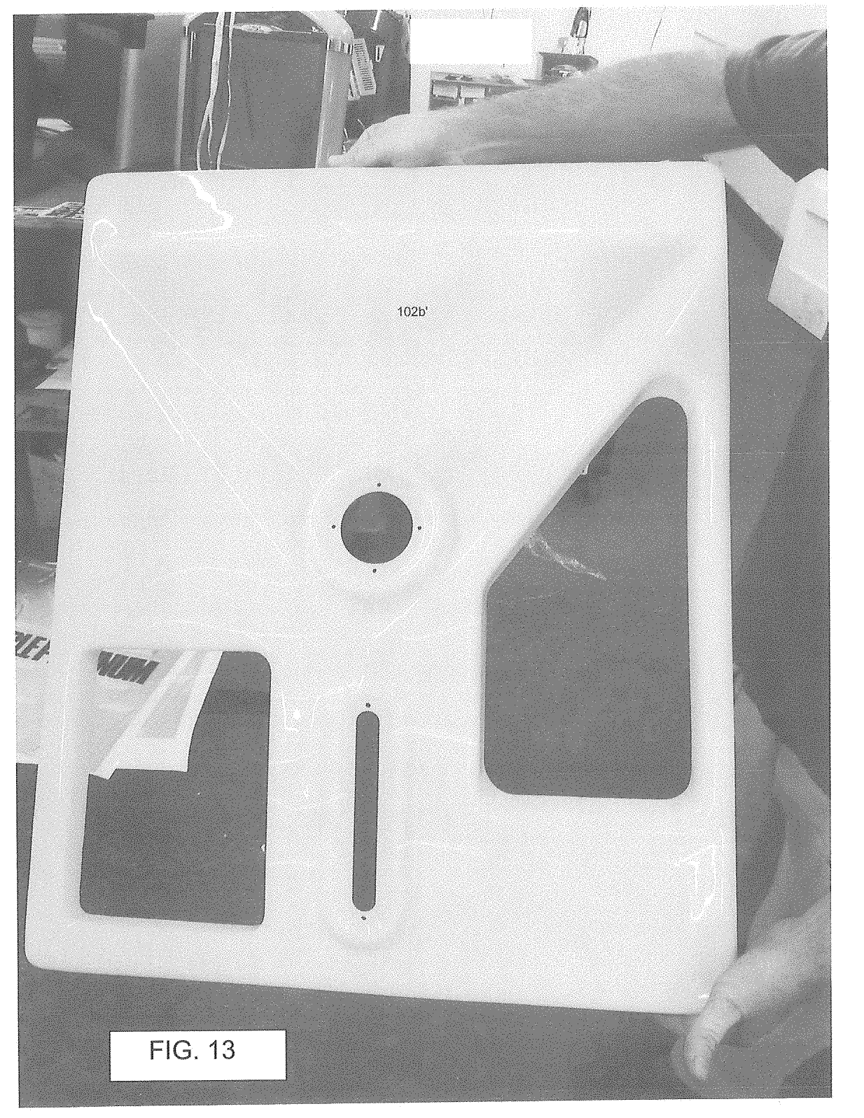

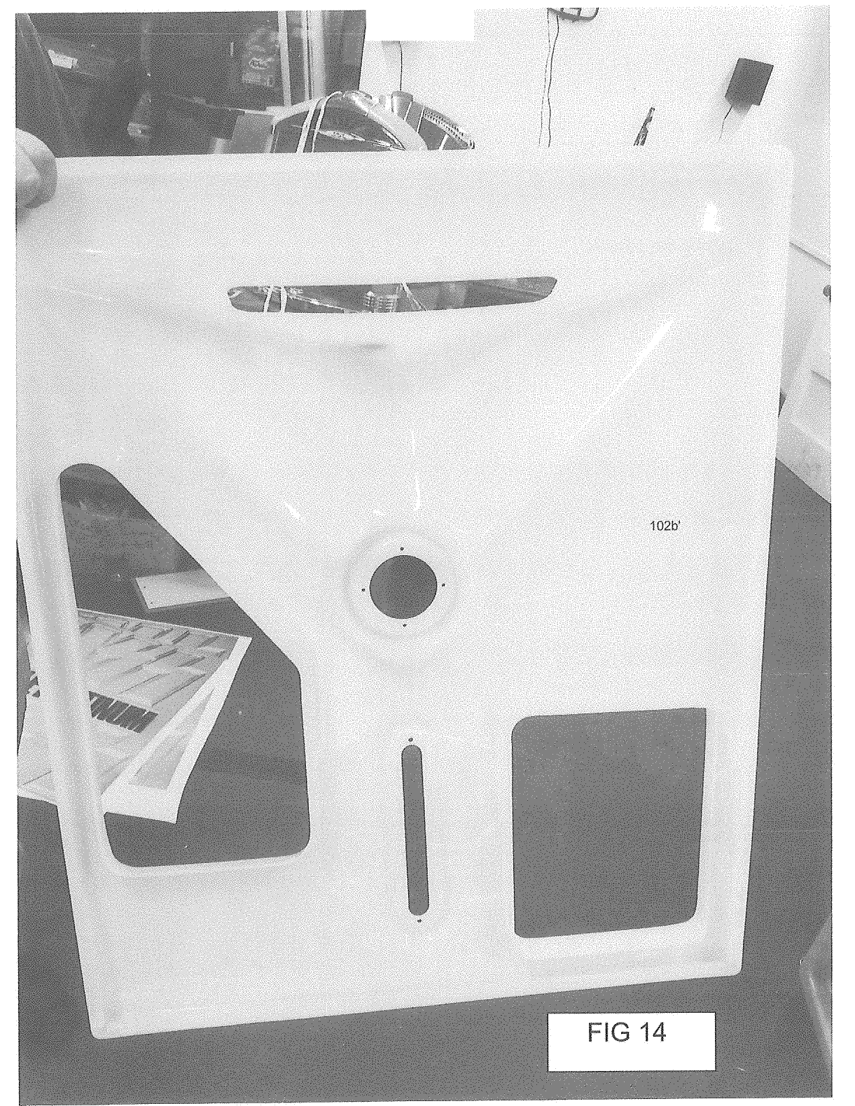

Provided on the inner side of housing 1, behind each translucent or semi-transparent panel 101b (and optionally 102b and/or 103b and/or 101c and/or 106) is a flexible strip 121 of single-color LEDs, typically a combination of red, green, and blue single-color LEDs. (See FIG. 12). These single-color LEDs, as shown by way of example as a red single-color LED 126, a green single-color LED 127, and a blue single-color LED 128 are connected to a control unit, not shown in FIG. 1, for controlling each of the single-color LEDs. In other words, the control unit and translucent or semi-transparent panels 101b (and optionally 102b and/or 103b and/or 101c and/or 106) are adapted to impart a determined impression of color to these panels. These single-color LEDs are positioned in close proximity to one another so as to enable the creation of blended colors and blended color impressions through the translucent or semi-transparent panels. That is, two or more single-color LEDs of different colors will be positioned in close proximity such that those LEDs can be controlled together to create a blended color through the translucent or semi-transparent panels where the respective light emissions of each single-color LED overlap. Preferably, groupings of all three primary color (red, green, blue) single-color LEDs closely positioned together are created so as to allow the blending of all three primary colors through the translucent or semi-transparent panels to enable the widest range of blended colors. More preferably, the three primary color (red, green, blue) single-color LEDs are positioned no more than one centimeter apart. More preferably, the three primary color (red, green, blue) single-color LEDs are positioned no more than three millimeters apart.

The lower translucent or semi-transparent panel 101b of the front wall is a panel with a relief 110, the panel being further provided with a number of recesses 111, 112, 113. Recess 112 provides access to a coin slot 114 and a slot 115 typically coupled to a three-point locking. Recess 111 provides access to prize compartment 8. Arranged in recess 113 is a loudspeaker on which for instance a logo can be provided in the middle. Relief 110 creates the space required for the purpose of concealing the joystick 4, the button 5, the loudspeaker and other parts in the housing.

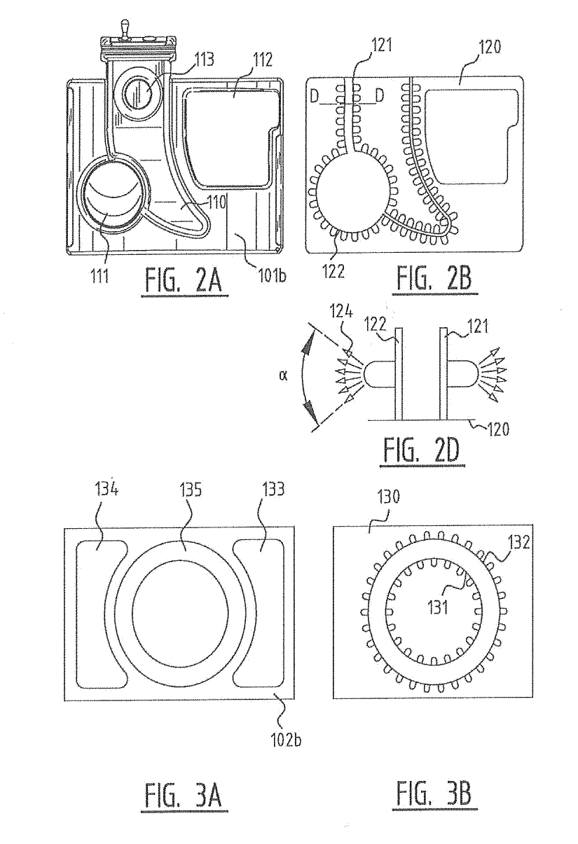

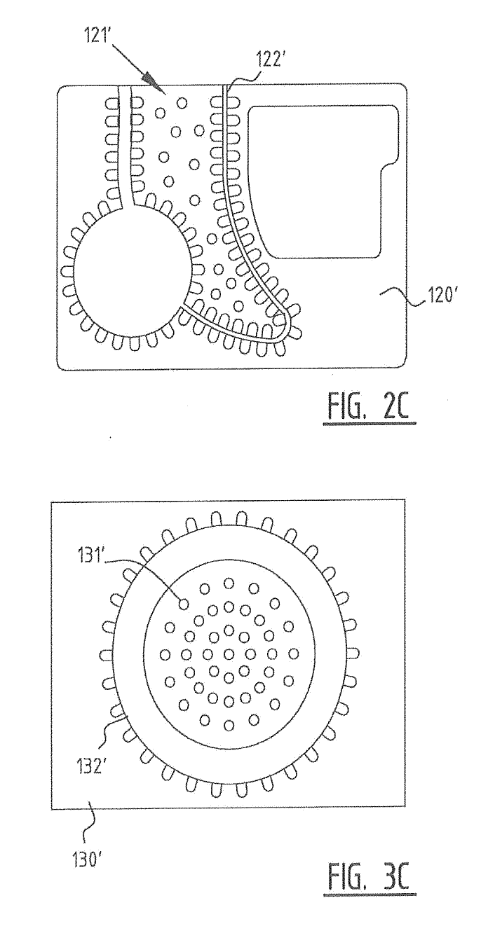

According to an exemplary embodiment, strips of single-color LED's 121, 122, each having a pattern or array of single-color LEDs for panel 101b are arranged on the inner side of the cabinet close to the periphery of this relief 110, close to opening 111 and at other locations. This is illustrated in FIGS. 2A and 2B. Panel 101b is arranged against a support plate 120 as shown in FIG. 2B, single-color LED arrays or strips 121, 122 are arranged against support plate 120. An actual single-color LED array or strip is depicted in the photograph of FIG. 12. As can be seen more clearly in the cross-section of FIG. 2D, the single-color LED strips 121, 122 are mounted vertically on support plate 120 such that the central emission direction is substantially parallel to front panel 101b. The central emission direction 124 is understood to mean the direction passing through the middle of the emission angle of a single LED, see FIG. 2D. Each of the single-color LEDs in the LED strip or array 121 is further directed toward the inner side of relief 110, while each of the single-color LEDs of the single-color LED strip or array 122 is directed outward in order to illuminate particularly the rest of panel 101b. FIG. 2C illustrates an alternative embodiment of support plate 120′ with a single-color LED array or strip 122′ (similar to the single-color LED strip 122), but with a single-color LED surface 121′ on which single-color LEDs are arranged in distributed manner and have for instance a central emission direction substantially perpendicular to support plate 120′. The distance between the translucent or semi-transparent panel and the single-color LEDs of the single-color LED arrays or strips 121′ and 122′, as seen along the central emission direction, should be great enough to allow the light emissions from closely positioned single-color LEDs to blend at least in part before or as they are passing through the translucent or semi-transparent panels, if such blended colors are so desired, and should preferably be at least 3 centimeters. This can be achieved in an advantageous manner for the single-color LEDs of the single-color LED surface 121′ by providing a relief, such as for instance relief 110.

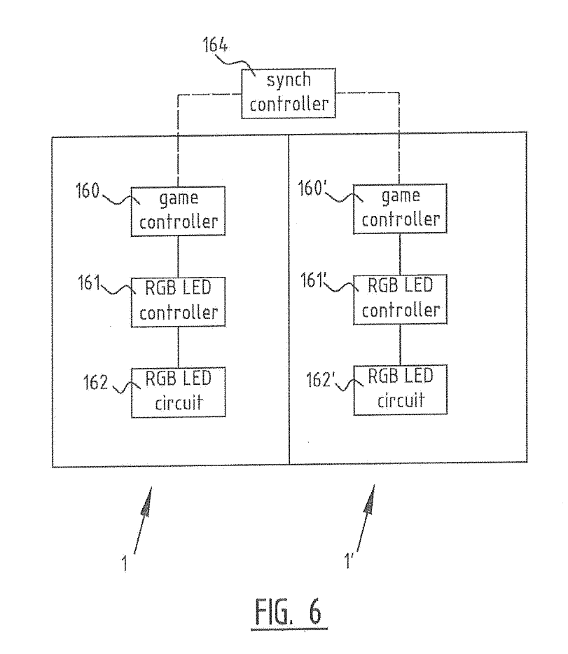

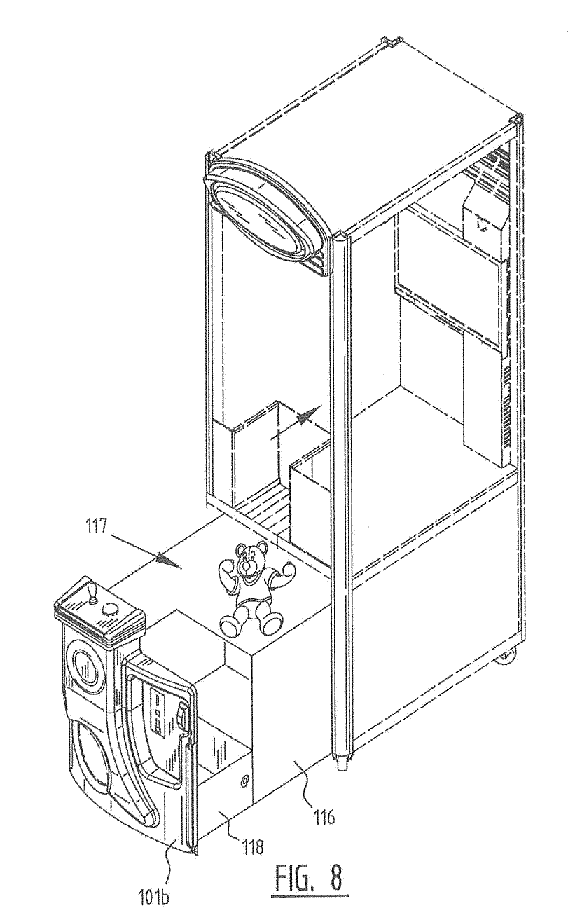

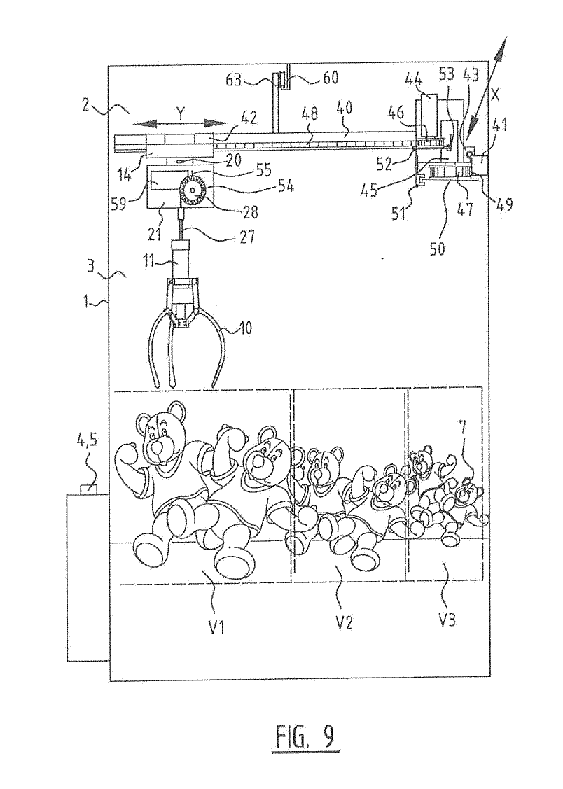

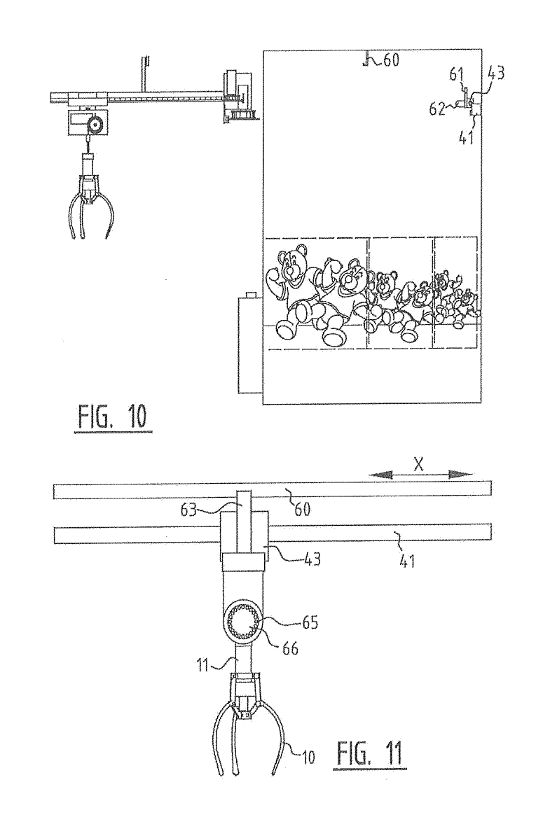

Support plate 120 is mounted against drawer 116 which fits under platform 6 and is shown in FIG. 8. This drawer can be provided with an additional storage compartment 117, a closable cash box 118 and the electronics such as the central game controller 160, which will be further elucidated herein below with reference to FIG. 6. Note that support plate 120 is not shown in FIG. 8, since it lies behind front panel 101b.

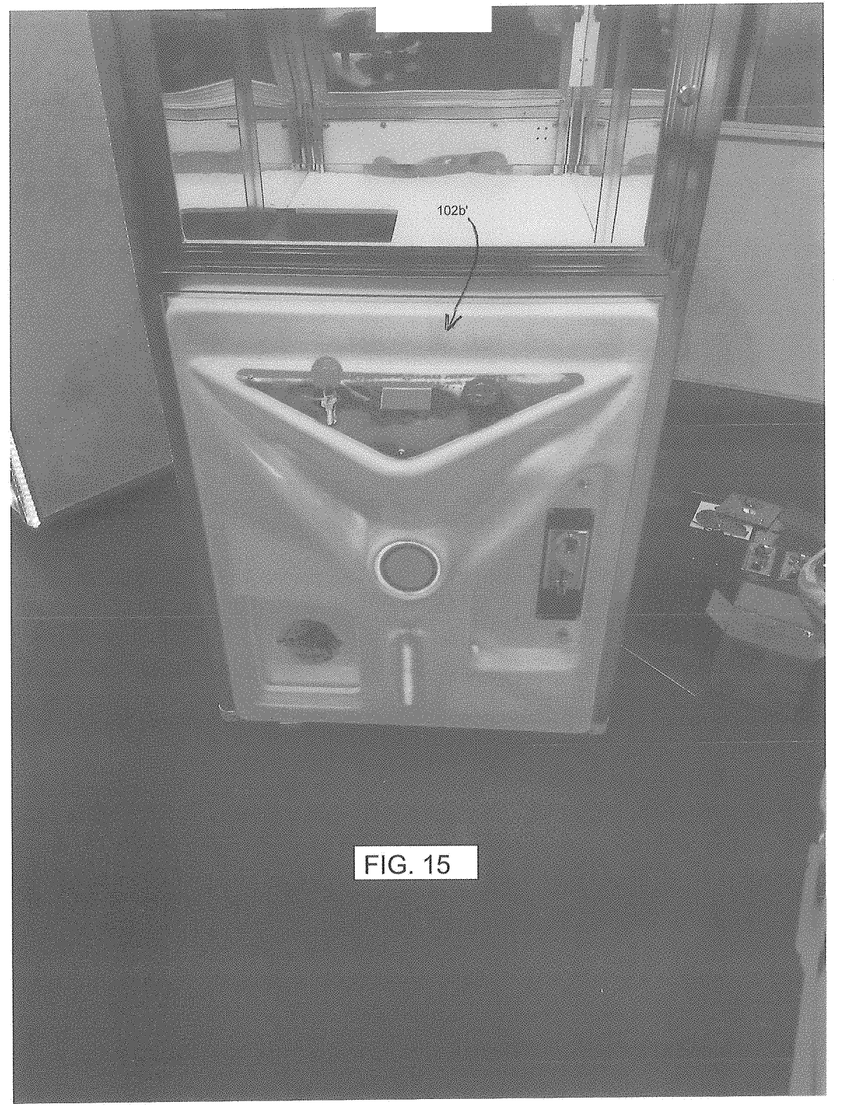

As illustrated in FIGS. 3A and 3B, use can also be made for side wall 102 or 103 of a lower translucent or semi-transparent panel 102b which is mounted against a support plate 130 on which a single-color LED pattern 131 is arranged. This support plate 130 is attached to the frame of cabinet 1, and supports the translucent or semi-transparent panel 102b which can also be provided with relief zones 133, 134, 135. In similar manner as for front panel 101b, two single-color LED strips 131, 132 are provided with single-color LEDs pointing respectively inward and outward. According to a variant, this can again also be implemented otherwise, and FIG. 3C illustrates an example in which single-color LED strip 131 is replaced by a single-color LED surface 131′. FIGS. 13 and 14 depict the front and back of yet another lower translucent or semi-transparent panel 102b′. FIG. 15 depicts the panel 102b′ illuminated by a pattern of single-color LEDs.

The skilled person will appreciate that many other single-color LED patterns can still be envisaged with which the desired effect, i.e., a more or less uniform illumination of the translucent or semi-transparent panel, i.e., without individual light spots being visible, can be achieved.

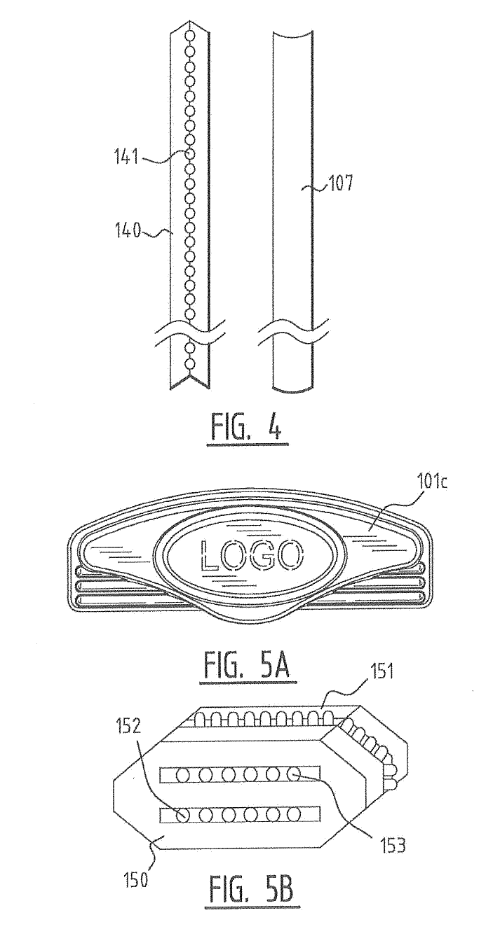

An example of the above described elongate translucent profile 107 is illustrated in FIG. 4, together with a corner profile 140 against which this profile 107 is mounted. An optionally continuous single-color LED tubing/strip is typically provided against this corner profile 140 in order to impart a determined impression of color to translucent profile 107. Strip 141 is for instance arranged parallel to the front wall against corner profile 140. The control unit and translucent profile 107 are adapted in similar manner to impart a determined impression of color to this profile 107.

As discussed with reference to FIG. 1, front wall 101 can be provided at the top with an additional translucent top panel 101c behind which a pattern or array of single-color LEDs and/or white LEDs is also provided, see FIGS. 5A and 5B. Use is also made here of a support plate 150 with a pattern or array of LED tubing 151-153 coupled to the control unit. This support plate 150 is fixed against the frame of the cabinet and carries on its front side the top panel 101c, this such that the single-color LED pattern can impart a determined impression of color to top panel 101c. Note that the LED strips 152, 153 typically comprise white LEDs and are intended to accentuate with white light the LOGO provided on panel 101c, see FIG. 5A. LED strip 151 typically comprises single-color LEDs and is intended to give the zone around the logo a determined color.

According to a further advantageous feature, a synchronization unit 164 is provided. This can be a separate unit provided outside game machine 1 or a unit built into one of the game machines of a set of adjoining game machines. This is shown schematically in FIG. 6, wherein two game machines are placed adjacently of each other. The central game controller 160 of each game machine 1, 1′ is adapted for coupling to a synchronization unit 164 for synchronizing the different game machines 1, 1′, and in particular control unit 161, 161′ thereof, for the purpose of controlling corresponding single-color LED circuits 162, 162′. Adjoining game machines can in this way change color at the same times, for instance in order to obtain a rainbow effect. Synchronization module 164 is typically an external component, but can also be accommodated in one of the game controllers 160, 160′. Game controller 160 can further be adapted to control, and particularly change, the light pattern in accordance with the stage of the game (for instance as a function of a win situation, a loss situation etc.). It is thus possible in a determined game situation to have for instance flashes of white light emitted by the single-color LEDs.

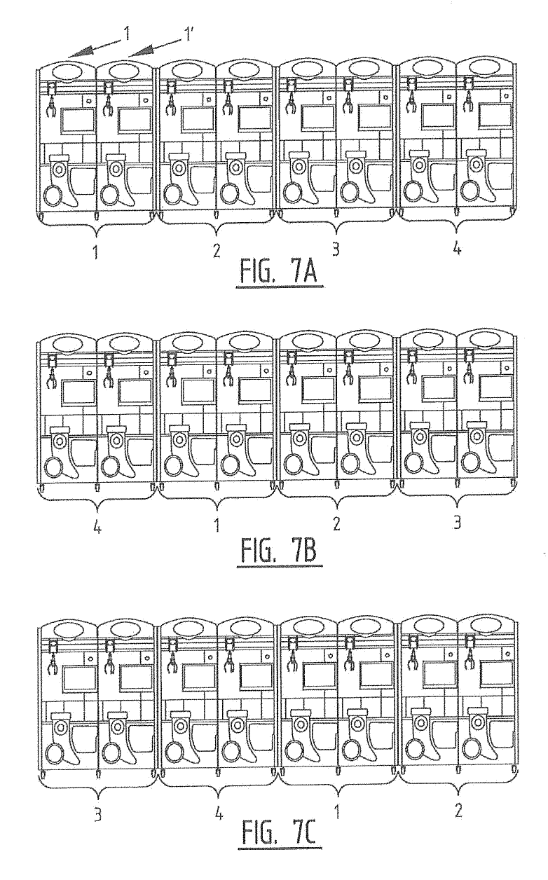

FIGS. 7A-C illustrate a number of adjoining game machines 1, 1′ etc., to which a determined impression of color is imparted in pairwise manner. FIG. 7A illustrates a first color sequence C1, C2, C3, C4 at a first point in time t1 for the eight machines placed adjacently of each other. This sequence changes to a second color sequence C4, C1, C2, C3 at time t2. This can be performed in perfectly synchronous manner by synchronization unit 164 illustrated in FIG. 6.

According to a variant (not shown) of the embodiment of FIG. 1, horizontal platform 6 could be embodied, instead of front panel 101b, as a translucent or semi-transparent panel under which a pattern or array of single-color LEDs is arranged. As a further variant, the bottom 106 could be translucent, wherein the pattern or array of single-color LEDs is arranged above the bottom to create a colored glow under the game machine.

According to yet another variant (not shown) of the embodiment of FIG. 1, granules can be provided in cabinet 1 on horizontal platform 6. These are typically plastic granules (granulate) manufactured from a semi-transparent or translucent material, and for instance from polycarbonate (PC). In such an embodiment the LED pattern could be provided on or under platform 6, wherein light from the LEDs is emitted by diffusion through the granule layer, thus imparting a uniformly distributed impression of color to the granules. According to another variant, a pattern or an array of single-color LEDs can be provided on the inner side of the front wall just above platform 6, such that the LEDs emit light in the direction of the granules arranged on platform 6. A light glow in a determined color is in this way obtained which moves from front to rear. It will be self-evident that these measures (translucent front panel 101b, translucent side panel, translucent bottom 106, translucent horizontal platform, granules etc.) can be combined in one or more combinations in order to achieve a particular intended effect.

The exemplary embodiment of the game machine of FIG. 1 is further provided with a screen 12, for instance a 22-inch LCD screen or similar, and a camera 13 placed against the inner side of rear wall 104. Although these features of the invention are illustrated here specifically for a game machine with grabber, the skilled person will appreciate that these will also find application in other types of game machines. The control means of the game machine can for instance be adapted such that, when a player wins, he/she is photographed by camera 13. The photo of the player can for instance then be displayed, after he/she has given consent, in a so-called “winners gallery” displayed on screen 12. The most recent winner or a determined number of most recent winners can for instance be shown on the screen.

Sound animation means and/or display means may further be controlled from the control unit. Specific effects may then occur in the case of a loss or win which make the game even more attractive, see also the description above relating to the coupling between the central game controller 160 and LED controller 161. It is further possible to provide the user with extra credit in certain situations, for example when an object is lost, and/or to enable a new grabbing session, for example by illuminating a repeat grab button.

Changes can be made in the above constructions without departing from the scope of the disclosure, it is intended that all matter contained in the above description or shown in the accompanying drawings shall be interpreted as illustrative and not in a limiting sense.

What is claimed is:

1. A game machine, comprising:
a housing with a plurality of upright walls, said housing being adapted to accommodate playing apparatus; said plurality of upright walls comprising a light diffusing panel;
a pattern of single-color LEDs provided on the inner side of the housing, behind and directed at least in part toward, the light diffusing panel;
a controller operatively connected to each of the single-color LEDs in the pattern of single-color LEDs, the controller adapted to selectively control each of the single-color LEDs so as to impart a determined impression of color to the light diffusing panel.

2. The game machine of claim 1, wherein the controller controls two or more different color single-color LEDs so as to blend the light emitted by said two or more different color single-color LEDs to produce at least in part said determined impression of color to the light diffusing panel.

3. The game machine of claim 1, wherein the controller is operatively connected to a main game board of the game machine.

4. The game machine of claim 1, wherein the playing apparatus comprises a pick-up mechanism, said pick-up mechanism adapted to pick up one or more objects within the housing.

5. The game machine of claim 1, wherein the light diffusing panel is at least in part translucent or semi-transparent.

6. The game machine of claim 1 wherein the pattern or array of single-colored LEDs is arranged such that a substantially uniform impression of color is imparted to said at least one translucent or semi-transparent panel.

7. The game machine of claim 1, wherein the pattern of single-color LEDs comprises an array.

8. The game machine of claim 1, wherein the color of the single-colored LEDs are selected from a group consisting of: red, green, blue, white, or gold.

9. The game machine of claim 1, wherein the at least one translucent or semi-transparent panel is manufactured from a material with a light transmission lying between 10% and 60%, preferably between 20% and 50%, and more preferably between 35% and 45%.

10. The game machine of claim 1, wherein the at least one translucent or semi-transparent panel is manufactured from a white translucent material.

11. The game machine of claim 1, wherein the translucent or semi-transparent panel is manufactured from a material having good light diffusion properties, preferably having a light diffusion factor lying between 0.70 and 1.00.

12. The game machine of claim 1, wherein the at least one translucent or semi-transparent panel comprises a panel with a relief; a pattern or array of single-color LEDs being arranged along the edge of this relief, said single-colored LEDs having a central emission direction directed substantially toward the inner side of the relief.

13. The game machine of claim 1, wherein the pattern or array of single-colored LEDs is arranged such that the central emission direction of single-colored thereof is substantially parallel to the translucent or semi-transparent panel behind which said LED is provided.

14. The game machine of claim 1, wherein the upright walls comprise a front wall, wherein said at least one translucent or semi-transparent panel comprises a lower front panel; said front wall consisting substantially of said lower translucent front panel and a semi-transparent panel mounted there above.

15. The game machine of claim 1, wherein the upright walls further comprise a first side wall adjacent the front wall; said at least one translucent or semi-transparent panel comprising a lower side panel; said first side wall consisting substantially of said lower translucent side panel and a semi-transparent panel mounted there above.

16. The game machine of claim 1, wherein an edge between the front wall and first side wall is provided with an elongate profile of a translucent material behind which a pattern or array of single-colored LEDs is arranged, wherein the control unit and said translucent profile are adapted to impart a determined impression of color to said profile.
